(19) United States
(12) Patent Application Publication
(10) Pub. No.: US 2011/0296801 A1
(43) Pub. Date: Dec. 8, 2011

(54) ROLLABLE CHAIRMAT

(76) Inventor: Albert B. Cheris, Buffalo Grove, IL (US)

(21) Appl. No.: 12/794,273

(22) Filed: Jun. 4, 2010

(51) Int. Cl. B65B 1/04; B32B 3/30; A47G 27/02

(52) U.S. Cl. 53/473; 428/167; 428/169

(57) ABSTRACT

A rollable chairmat is provided that comprises a sheet of polymeric material having a plurality of parallel grooves across one of its surfaces. Adjacent grooves define a rib therebetween, with each rib defining a peak and each groove defining a valley. The grooves and ribs may run lengthwise, widthwise, or obliquely relative to the width and length of the chairmat. A method for storing a chairmat is also provided in which a grooved chairmat is rolled up into a tube, and the chairmat is maintained in its tubular configuration, by, e.g., placing it in a tube, encasing it in shrink-wrap, utilizing a strap or adhesive strip, or placing it in a box.

### BACKGROUND

Desk chairmats are widely used in home and office settings to protect the underlying flooring or carpeting from excessive wear and to facilitate smooth rolling of the chair casters. The lower surface of the chairmat is commonly provided with a friction-enhancing finish to maintain the chairmat in place. If the chairmat is to be used on a carpeted surface, this typically comprises a series of short cleats or spikes that will engage the pile of the carpeting to maintain the chairmat and its desired location.

Because chairmats are relatively large and generally fairly rigid, they are difficult to carry or otherwise handle. This is particularly true for chairmats with carpet spikes, as the spiked surface makes handling such a chairmat potentially uncomfortable or may even cause injury. The unwieldy nature of chairmats has also lead to difficulties in their retail marketing, particularly with their display and storage or stocking. One approach for addressing the handling, storage and display issues has been to make the chairmats foldable, thus reducing their size. This is shown, e.g., in U.S. Patents, U.S. Pat. No. 4,784,888, U.S. Pat. No. 5,073,428, and U.S. Pat. No. 6,284,341. Chairmats that may be rolled up into a tubular configuration have also been developed. However, these rollable chairmats have been relatively thin (on the order of 0.10″ thick), which has resulted in unsatisfactory durability, and were rollable into tubes having a relatively large diameter (on the order of 7″). While the development of the prior art foldable and rollable chairmats has attempted to address the handling, shipping and storage problems, these issues persist, and improvement is desirable.

### SUMMARY OF THE DISCLOSURE

In accordance with the present disclosure, a chairmat is provided that has an upper surface and a lower surface, with the lower surface for contacting a flooring surface and the upper surface for supporting a chair. The chairmat comprises a sheet of polymeric material that has a plurality of parallel grooves across at least one of the surfaces. In one embodiment of the chairmat, adjacent grooves define a rib therebetween, with each rib having a peak and each groove defining a valley between adjacent ribs. The distance between the lower surface of the chairmat and the valleys is at least about 0.025″, while the distance between the lower surface of the chairmat and the peaks of the ribs being from about 0.075″ to 0.200″.

In a further aspect of the disclosure, the peaks of the ribs may be flat or they may be rounded, with a radius of, preferably, 0.005″. In addition, the grooves preferably have a width of less than or equal to 0.125″, while the ribs preferably have a width of less than or equal to 3.0″.

In another aspect of the disclosure, the grooves and the ribs may extend lengthwise, widthwise, or obliquely relative to the length and width of the chairmat.

In another aspect of the disclosure, a method for storing a chairmat is provided. Pursuant to the method, a chairmat is provided that has an upper and lower surface with the lower surface for contacting a flooring surface and the upper surface for supporting a chair. The chairmat is formed of a polymeric material, in which a plurality of grooves are made across one of the surfaces of the chairmat. The chairmat is then rolled into a tubular configuration. The chairmat may be maintained in its tubular configuration by playing it in a tube, encasing it in shrink-wrap, by using a strap, by using a circumferential adhesive strip or placing it in a box.

Other features and advantages of the chairmat will become apparent by reference to the accompanying drawings and following detailed description.

### BRIEF DESCRIPTION OF THE DRAWINGS

FIG. 1 is a perspective view showing the top surface of a first embodiment of a chairmat according to the present disclosure.

FIG. 2 is an enlarged fragmentary perspective view of a portion of the chairmat of FIG. 1,

FIG. 3 is a fragmentary top view of the chairmat of FIG. 1.

FIG. 4 is a fragmentary side view of the chairmat of FIG. 1, including a plurality of carpet-engaging projections on the lower surface thereof.

FIG. 5 is a fragmentary side view of an alternative embodiment to FIG. 3 in which the carpeting-engaging projections are located on the peeks of the ribs of the chairmat.

FIG. 6 is a fragmentary bottom view of the chair mat of FIG. 4.

FIG. 7 is a fragmentary bottom view of the chairmat of the FIG. 5.

FIG. 8 is a perspective view showing the method in which a chairmat according to the present disclosure is rolled into a tubular configuration and is maintained in the tubular configuration by placing it into a tube.

### DETAILED DESCRIPTION

Exemplary embodiments of a chairmat according to the present disclosure are illustrated herein. It will be apparent to those of ordinary skill in the art, these particular embodiments may be reconfigured without departing from the scope and spirit of the present disclosure. However, the exemplary embodiments may include optional steps, methods and features that one of ordinary skill would recognize as not being required to fall within the scope of the present disclosure.

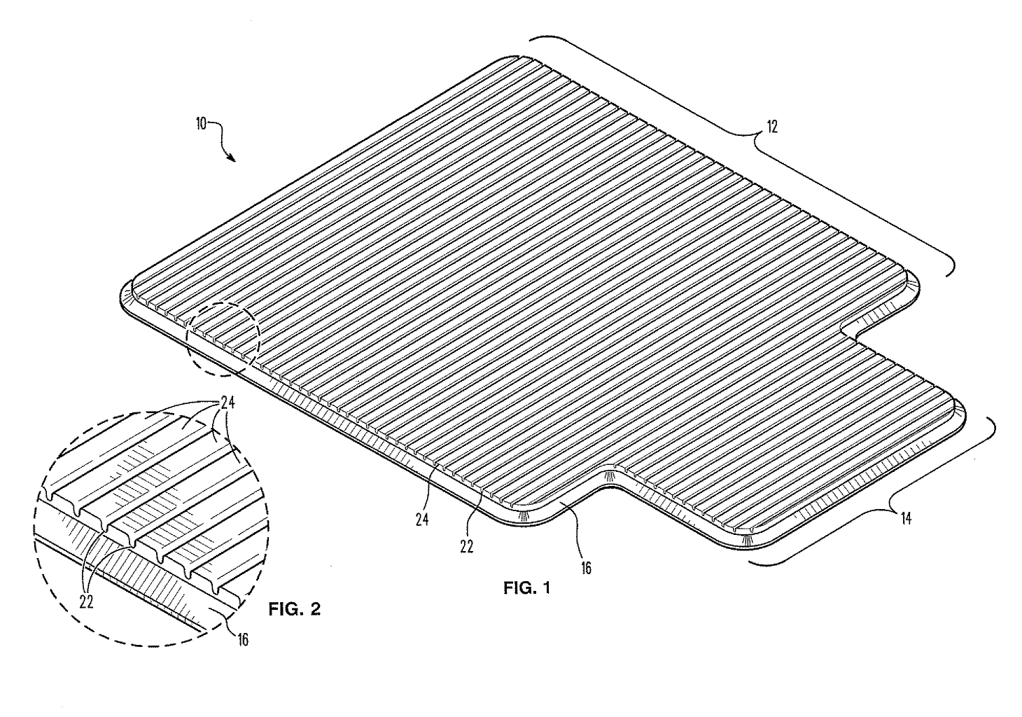

Turning to FIG. 1, there is a first embodiment of a chairmat, according to the present disclosure, generally designated 10. As is typical, the illustrated chairmat includes a larger, generally rectangular portion 12 on which a castered chair would sit, and a smaller rectangular portion 14 that would fit underneath a desk, where a person's feet would typically be when seated at the desk. Of course, the chairmat 10 may take other shapes without departing from the disclosure.

As is well known in the art, the chairmat may be formed of a polymeric material. Such materials may include polyvinylchloride, polycarbonates, acrylics, polypropylene, and polyesters, such that a semi-rigid structure results.

As seen in FIG. 1, the chairmat 10 has an edge portion 16 that may be beveled or tapered to facilitate rolling a chair onto and off of the edge of the chairmat 10, and to reduce the likelihood of tripping over a raised edge. However, the inclusion of a beveled edge is optional, and it may be omitted without departing from the scope of the disclosure.

In keeping with the disclosure, at least one of the surfaces of the chairmat is formed with a plurality of parallel grooves extending across substantially the entire surface, with adjacent grooves defining a rib therebetween, with each rib defining a peak and each groove defining a valley between adjacent ribs.

With reference to FIGS. 1 and 2, the chairmat 10 has an upper surface 18 and a lower surface 20. The lower surface 20 contacts the flooring on which the chairmat is placed, while the upper surface 18 supports a chair. A plurality of grooves 22 is formed across the upper surface 18 so as define ribs 24 therebetween. While the grooves 22 and ribs 24 are shown in FIGS. 1 and 2 as being formed in the upper surface 18 of the chairmat, the grooves 22 and ribs 24 could alternately be formed in the lower surface 20 without departing from the disclosure.

As illustrated in FIG. 1, the grooves 22 and ribs 24 extend across the width of the chairmat. Alternatively, the grooves and ribs can extend lengthwise (at 90° to the orientation shown in FIG. 1), or obliquely relative to the length and width of the chairmat (e.g. between opposite corners), again without departing from the scope of the disclosure.

In use, it is common for chairmats to crack and break due to the repeated rolling of a chair across their surfaces. In the context of the chairmat disclosed herein, the appropriate selection of the thickness of the chairmat and the depth and spacing of the grooves are important for providing a chairmat that has satisfactory fatigue characteristics, and to also provide for the smooth rolling of the chair across the grooved surface.

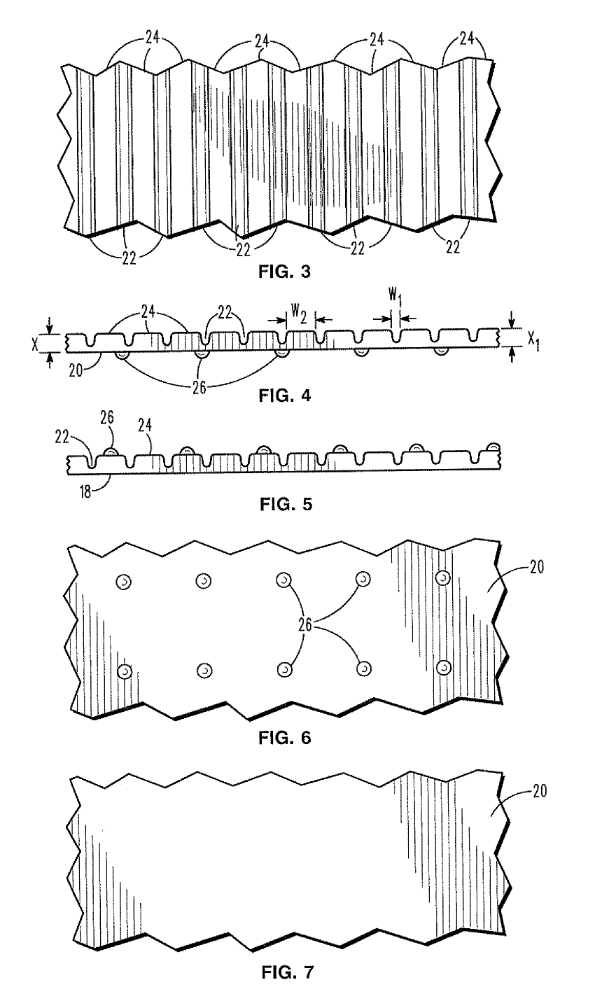

With reference to FIGS. 3 and 4, this can be achieved by providing a chairmat that has a thickness X (i.e., the distance between the lower surface 20 and the upper surface 28 of the chairmat) of from about 0.75″ to 0.200″. In such a chairmat, the grooves 22 are formed so that the distance X₁ between the lower surface of the chairmat and the valleys or bottoms of the grooves 22 are to least about 0.025″. In addition, the grooves 22 preferably have a width W₁ of less than or equal to 0.125″, while the ribs preferably have a width W₂ of less than or equal to 3.0″. Such a configuration should permit the chairmat to be rolled up into a tubular configuration having an outside diameter of as small as 4½″, and should withstand the repeated rolling of weighted casters over the chairmat. In addition, such a spacing of the grooves 22 and the ribs 24 should also permit the chair casters to ride smoothly over the grooved surface.

As seen in FIG. 3, the ribs 24 have peaks that present a flat surface. However, the peaks may be rounded and, if rounded, the peaks of the ribs 24 preferably have a radius of approximately 0.005″.

With reference to FIGS. 4-6, the chairmat may be provided with a plurality of projections 26 on its lower surface for engaging the pile of a carpet to maintain the chairmat in place. As seen in FIGS. 4 and 6, the projections 26 are formed on the side of the chairmat opposite to the grooves 22 and ribs 24. However, it is shown in FIG. 5, the projections 26 may be formed on the peaks of the ribs 24, without departing from the scope of the disclosure. Of course, other techniques for enhancing the frictional engagement of the lower surface of the chairmat with the flooring may be used in place of the projections 26 without departing from the disclosure. For example, the lower surface of the chairmat may be textured with cross-hatching or have an adhesive substance applied thereto to make it tacky. If the lower surface includes the ribs 24, the ribs may be knurled or formed to have spaced notches along their length, so as to present a saw-toothed configuration.

In a further alternative, the lower surface that engages the flooring may be smooth, as shown in FIG. 7, which is appropriate for use on a hard flooring surface.

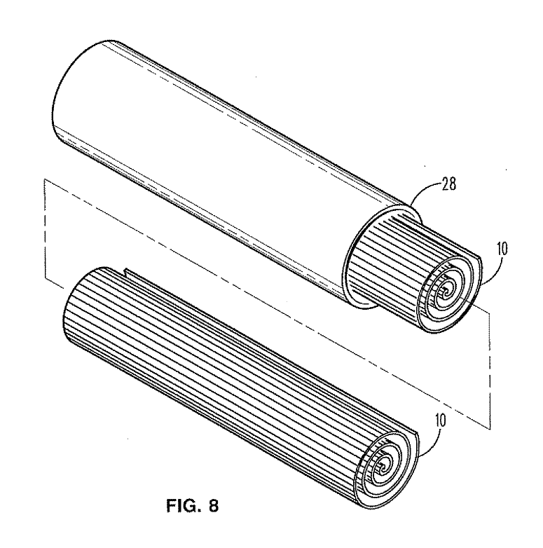

With the provision of a chairmat, as is described above, ease of handling and storage may be achieved by rolling the chairmat 10 into a tubular configuration, as shown in FIG. 8 and then maintaining the tubular configuration until it is desired to unroll the chairmat. The tubular configuration may be maintained by, for example, placing the chairmat in a tube 28, as shown in FIG. 8. Alternatively, the chairmat may be maintained in its tubular configuration by encasing it in shrink-wrap, by the use of a strap around the circumference of the tube, by means of a circumferential adhesive strip, or by placing the chairmat in a box.

The chairmat may be rolled up with the grooves 22 either on the inside surface or the outside surface. If the chairmat is provided with carpet-engaging projections 26, the chairmat 10 may be rolled up with the projections 26 on the inside so that a person handling the rolled up chairmat is not exposed to the projections 26.

Thus, a rollable chairmat has been provided in which the chairmat can be rolled up into a tubular configuration to provide for easy handling by a consumer and additional options for storage and display. In the rolled up configuration, at least 50% more product should be able to be displayed and stored in the same space. In addition, the formation of the grooves and the surface of the chairmat reduces the overall weight with savings on the order of 25% being reasonably achievable. Of course, the reduced weight also facilitates the ease of handling of the chairmat and also is indicative of the reduction in the amount of material needed to form the chairmat, which should translate into savings and material costs. Further, a grooved chairmat, as described herein, should lay flatter than the prior art foldable chairmats.

While exemplary embodiments have been described and illustrated, changes may be made to these embodiments without departing from the scope of the invention which is defined by the claims. Further, it is not necessary to meet any or all of the identified advantages of the disclosed rollable chairmat in order to fall within the scope of the claims, and inherent and/or unforeseen advantages may exist even though they may not have been explicitly discussed herein.

1. A chairmat having an upper surface and a lower surface, the lower surface for contacting a flooring surface and the upper surface for supporting a chair, the chairmat comprising a sheet of polymeric material having a plurality of parallel grooves across at least one of the surfaces.

2. The chairmat of claim 1 wherein adjacent grooves define a rib therebetween, each rib defining a peak, with each groove defining a valley between adjacent ribs, the distance between the lower surface of the chairmat and the valleys being at least about 0.025″, and the distance between the lower surface of the chairmat and the peaks being from about 0.075″ to 0.200″.

3. The chairmat of claim 1 where the chairmat further has a length and a width and wherein the grooves and ribs extend lengthwise.

4. The chairmat of claim 1 having a length and a width and wherein the grooves and ribs extend widthwise.

5. The chairmat of claim 1 further having a length and a width and wherein the grooves and ribs extend obliquely relative to the length and the width.

6. The chairmat of claim 2 in which the peaks are rounded.

7. The chairmat of claim 6 in which the peaks have a radius of 0.005″.

8. The chairmat of claim 2 wherein the peaks are flat.

9. The chairmat of claim 2 wherein the grooves have a width of less than or equal to 0.125″.

10. The chairmat of claim 2 wherein the ribs have a width of less than or equal to 3.0″.

11. The chairmat of claim 2 wherein the grooves have a width of less than or equal to 0.125″ and the ribs have a width of less than or equal to 3.0″.

12. A method for storing a chairmat comprising:
providing a chairmat having an upper and lower surface, the lower surface for contacting a flooring surface and the upper surface for supporting a chair, the chairmat comprising a sheet of polymeric material;
making a plurality of grooves across at least one of the surfaces of the chairmat; and
rolling the chairmat into a tubular configuration.

13. The method of claim 12 wherein the chairmat is maintained in its tubular configuration by placing it in a tube.

14. The method of claim 12 wherein the chairmat is maintained in its tubular configuration by encasing it in shrink-wrap.

15. The method of claim 12 wherein the chairmat is maintained in its tubular configuration by a strap.

16. The method of claim 12 wherein the chairmat is maintained in its tubular configuration by a circumferential adhesive strip.

17. The method of claim 12 wherein the chairmat is maintained in its tubular configuration by placing it in a box.
